(19) United States
(12) Patent Application Publication
(10) Pub. No.: US 2007/0280084 A1
(43) Pub. Date: Dec. 6, 2007

(54) Optical pickup

(75) Inventor: Kazuhiro Takahashi, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/809,310

(22) Filed: May 31, 2007

(30) Foreign Application Priority Data
Jun. 1, 2006 (JP) 2006-153322

(51) Int. Cl. G11B 7/00

(52) U.S. Cl. 369/112.02; 369/44.15

(57) ABSTRACT

The present invention provides an optical pickup capable of efficiently and cheaply preventing response speed of a liquid crystal device from decreasing when temperature is low. A liquid crystal device as aberration correcting means is fixed inside of a first movable holder so as to cover an opening. An objective lens is fixed to a second movable holder so as to cover an opening. A focusing coil is disposed on a side face of the second movable holder. Both ends of a heat transfer plate having heat conductivity and flexibility are bonded to the focusing coil by an adhesive having heat conductivity and adhesiveness. In a state where the second movable holder is fit and fixed to the inside of the first movable holder, the heat transfer plate is positioned inside of the first movable holder and a center portion of the heat transfer plate is in contact with an outside portion of an effective area capable of transmitting a laser beam in the liquid crystal device to transfer heat generated by the focusing coil to the liquid crystal device.

### BACKGROUND OF THE INVENTION

1. Field of the Invention

The present invention relates to an optical pickup having a liquid crystal device for correcting aberration by changing the phase of transmission light.

2. Description of the Background Art

Some of optical pickups built in an optical disk drive or the like are equipped with a liquid crystal device as aberration correcting means. The liquid crystal device is disposed on an optical path of light emitted from a light source and incident on an objective lens, and partly varies transmittance while passing the light from the light source to change the phase of transmission light, thereby correcting aberration. Since the liquid crystal device has a characteristic such that its response speed decreases when temperature is low, the countermeasure against drop in the response speed has been conventionally proposed.

For example, in Japanese Patent Application Laid-Open No. 2006-12245, temperature is detected by temperature detecting means such as a thermocouple provided for a liquid crystal device or the like. When the detected temperature is equal to or less than reference temperature, drive current of a movable part or alternate current having frequency higher than that of the drive current is passed to an electromagnetic coil for slightly moving the movable part, thereby heating the liquid crystal device. In Japanese Patent Application Laid-Open Nos. 2001-141992, 2005-235340, and 2005-56449, an ITO (Indium-tin-oxide alloy) film deposited on a glass face in a process of manufacturing the liquid crystal device or a heat generating member made by a coil is provided in or the surface of the liquid crystal device. By passing current to the heat generator, the liquid crystal device is heated.

However, only by passing current to the electromagnetic coil for slightly moving the movable part as in Japanese Patent Application Laid-Open Publication No. 2006-12245, heat generated by the electromagnetic coil dissipates into the air. Consequently, the liquid crystal device cannot be efficiently heated, and electric power is uselessly consumed. In the case of integrally forming the heat generator in the process of manufacturing the liquid crystal device as in Japanese Patent Application Laid-Open Nos. 2001-141992, 2005-235340, and 2005-56449, the number of manufacturing steps is large, and the cost of the liquid crystal device is high. In an optical pickup manufacturer, who purchases a liquid crystal device from a liquid crystal device manufacturer and manufactures an optical pickup, the cost of an optical pickup is high. Further, when a heat generator is provided on the inside of the liquid crystal device, there is the possibility that the performance of the liquid crystal device deteriorates like in the case where the transmittance of the liquid crystal device decreases and it deteriorates aberration.

### SUMMARY OF THE INVENTION

The present invention is directed to solve the above-described problems and an object of the invention is to provide an optical pickup capable of efficiently and cheaply preventing the response speed of a liquid crystal from decreasing when temperature is low.

The present invention provides an optical pickup including: a light source for emitting light; an objective lens for adjusting focal point of light from the light source onto an optical disk; a liquid crystal device for correcting aberration by changing phase of transmitting light on an optical path of the light from the light source; a movable holder for holding the objective lens and the liquid crystal device; a stationary frame for movably supporting the movable holder; and an electromagnetic coil and magnetic field generating means for slightly moving the movable holder relative to the stationary frame, wherein the movable holder is constructed by a first movable holder in which an opening is formed and a second movable holder which is fit and fixed to the inside of the first movable holder and in which an opening is formed so as to communicate with the opening in the first movable holder, the liquid crystal device is fixed inside of the first movable holder so as to cover the opening, the objective lens is fixed to the second movable holder so as to cover the opening, the electromagnetic coil is disposed on a side face of the second movable holder, and the optical pickup further includes a heat transfer member having heat conductivity for transferring heat generated by the electromagnetic coil to the liquid crystal device, whose end of the heat transfer member being bonded to the electromagnetic coil by bonding means having heat conductivity and adhesiveness, which is disposed inside of the first movable holder in a state where the first and second movable holders are fixed, and whose center portion is in contact with an outside portion of an effective area capable of transmitting light from the light source in the liquid crystal device.

With such a configuration, heat generated by the electromagnetic coil for slightly moving the movable holders is certainly transferred to the liquid crystal device by the heat transfer member disposed inside of the first movable holder and dissipation of heat into the air is suppressed. Consequently, electric power is not uselessly consumed, the liquid crystal device can be efficiently heated, and the response speed of the liquid crystal device can be prevented from decreasing when temperature is low. Since it is unnecessary to integrally provide a heat generator such as an ITO film for the liquid crystal device at the stage of manufacturing the liquid crystal device, the cost of the liquid crystal device and the optical pickup can be suppressed. Further, since no heat generator is provided inside of the liquid crystal device, it can prevent the situation that the transmittance of the liquid crystal device drops and it causes deterioration in aberration. Since the center portion of the heat transfer member is in contact with the outside portion of the effective area of the liquid crystal device, the amount of light passing through the liquid crystal device is not decreased, and the performance of the liquid crystal device can be prevented from deteriorating.

In the present invention, the heat transfer member is also in contact with a face of the second movable holder facing the outside portion of the effective area of the liquid crystal device in a state where the first and second movable holders are fixed.

With the configuration, the heat transfer member and the liquid crystal device are sandwiched by facing surfaces of the first and second movable holders and closely attached to each other by secure surface contact. Consequently, the heat generated by the electromagnetic coil is transferred to the liquid crystal device via the heat transfer member more reliably. Thus, while further suppressing useless consumption of the electric power, the liquid crystal device is efficiently heated, and decrease in the response speed of the liquid crystal device when temperature is low can be prevented.

In the present invention, the optical pickup may include, in place of the heat transfer member, a heat generating member for generating heat when electric power is supplied, the heat generating member being sandwiched together with the outside portion of an effective area capable of transmitting light from the light source in the liquid crystal device between facing surfaces of the first and second movable holders and closely attached to the outside portion in a state where the first and second movable holders are fixed, and a power supply line for supplying electric power to the heat generating member.

With the configuration, the heat transfer member and the liquid crystal device are sandwiched by facing surfaces of the first and second movable holders and closely attached to each other by secure surface contact. Consequently, by supplying electric power to the heat generating member via the power supply line to make the heat generating member generate heat, the heat is directly transferred to the liquid crystal device, and dissipation of heat into the air is suppressed. Without uselessly consuming electric power, the liquid crystal device can be efficiently heated, and the response speed of the liquid crystal device can be prevented from decreasing when temperature is low. The heat generating member is provided separately from the liquid crystal device and it is unnecessary to integrally provide a heat generator such as an ITO film for the liquid crystal device at the stage of manufacturing the liquid crystal device, so that the cost of the liquid crystal device and the optical pickup can be suppressed. Further, since no heat generator is provided inside of the liquid crystal device, it can prevent the situation that the transmittance of the liquid crystal device drops and it causes deterioration in aberration. Since the heat generating member is in contact with the outside portion of the effective area in the liquid crystal device, the amount of light passing through the liquid crystal device is not decreased, and the performance of the liquid crystal device can be prevented from deteriorating.

In the present invention, the optical pickup may further include, in addition to the heating member and the power supply line: detecting means for receiving light reflected from an optical disk and detecting an electric signal; driving means for driving the liquid crystal device; and control means for detecting temperature on the basis of the electric signal detected by the detecting means and a set value set in the driving means in order to drive the liquid crystal device and, on the basis of a result of comparison between the detected temperature and predetermined reference temperature, controlling supply of electric power to the heat generating member. In a typical embodiment, only in the case where the detected temperature is lower than a predetermined reference temperature, the control means supplies electric power to the heat generating member to make the heat generating member generate heat.

With the configuration, only when the detected temperature is lower than the predetermined reference temperature, electric power is supplied to the heat generating member to make the heat generating member generate heat via the power supply line. When the detected temperature becomes equal to or higher than the predetermined reference temperature, the supply of electric power to the heat generating member is stopped so that the heat generation of the heat generating member can be stopped. Consequently, while further suppressing useless consumption of electric power, the liquid crystal device can be efficiently heated, and decrease in the response speed of the liquid crystal device at low temperature can be prevented. In addition, it is unnecessary to separately provide temperature detecting means, so that the cost of the optical pickup can be suppressed to be low.

Further, in a typical embodiment of the present invention, the light source is made of a semiconductor laser device for emitting a laser beam, the magnetic field generating means is made of a magnet, the bonding means is made of an adhesive having heat conductivity and adhesiveness, and the heat transfer member is made of a heat transfer plate having heat conductivity and flexibility.

By using parts having high general versatility or high mass productivity as described above, the number of parts is reduced, the cost of the parts is suppressed, and further reduction in the cost and improvement in assembling performance of the optical pickup can be realized. Since the heat transfer plate has flexibility, an end of the heat transfer plate can be bonded to the electromagnetic coil with the adhesive while allowing the situation such that the transfer heat plate is deflected in a state where the first and second movable holders are fixed and comes into contact with the liquid crystal device. Thus, the positioning of the heat transfer plate at the time of bonding is simplified, and the assembling performance of the optical pickup can be improved.

According to the present invention, heat generated by the electromagnetic coil for slightly moving the movable holder is certainly transferred to the liquid crystal device via the heat transfer member, or heat generated by the heat generating member provided separately from the liquid crystal device is directly transferred to the liquid crystal device. Consequently, without uselessly consuming electric power, the liquid crystal device is heated, and decrease in the response speed of the liquid crystal device when temperature is low can be efficiently prevented at low cost.

### BRIEF DESCRIPTION OF THE DRAWINGS

FIG. 1 is a schematic configuration diagram of an optical pickup according to an embodiment of the invention;

FIG. 2 is a schematic structure diagram of the optical pickup;

FIG. 3 is a cross section of a movable holder of the optical pickup;

FIG. 4 is a diagram showing a heat transfer plate of the optical pickup;

FIG. 5 is a cross section of another movable holder of the optical pickup;

FIG. 6 is a cross section of a movable holder of an optical pickup according to another embodiment;

FIG. 7 is a diagram showing a liquid crystal device of the optical pickup;

FIG. 8 is a cross section of another movable holder of the optical pickup;

FIG. 9 is a diagram showing the liquid crystal device of the optical pickup;

FIG. 10 is a cross section of another movable holder of the optical pickup;

FIG. 11 is a diagram showing power supply lines of the optical pickup;

FIG. 12 is a diagram showing another power supply lines of the optical pickup;

FIG. 13 is a flowchart showing a procedure of controlling a heat generating member of the optical pickup; and

FIG. 14 is a diagram showing a temperature characteristic table recorded on the optical pickup.

### DESCRIPTION OF THE PREFERRED EMBODIMENTS

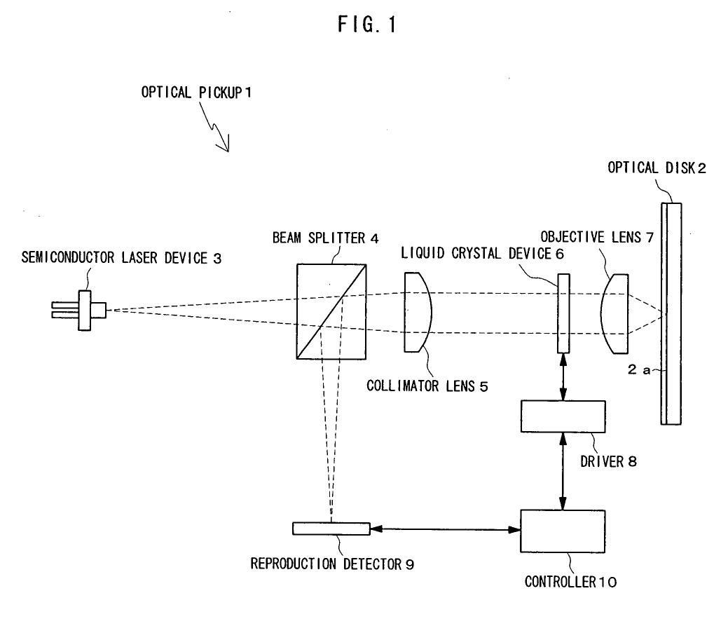

FIG. 1 is a schematic configuration diagram of an optical pickup 1 according to an embodiment of the present invention. The optical pickup 1 reads and reproduces information recorded on an information recording face 2a of an optical disk 2. A semiconductor laser device 3 is an example of a light source, and emits a laser beam. A beam splitter 4 transmits or reflects the laser beam. A collimator lens 5 converts a laser beam into parallel light. A liquid crystal device 6 is an example of aberration correcting means and disposed on the optical path of a laser beam. The liquid crystal device 6 partly varies the transmittance while passing a laser beam to change the phase of the transmitting laser beam and corrects wave front aberration caused by warping of the optical disk 2 or the like. An objective lens 7 adjusts the focal point of the laser beam to one point on the information recording face 2a of the optical disk 2. A driver 8 is an example of driving means for driving the liquid crystal device 6 by applying voltage to the liquid crystal device 6. A reproduction detector 9 is an example of detecting means for receiving light reflected by the optical disk 2 and detecting an electric signal. A controller 10 is an example of control means, consists of a CPU and a memory, and controls the electronic parts provided for the optical pickup 1.

A laser beam emitted from the semiconductor laser device 3 passes through the beam splitter 4 and is converted to parallel rays by the collimator lens 5. The parallel rays undergo aberration correction in the liquid crystal device 6, and the resultant rays are converged by the objective lens 7 onto the information recording face 2a of the optical disk 2. The light reflected by the optical disk 2 passes through the objective lens 7, the liquid crystal device 6, and the collimator lens 5 and is reflected the by beam splitter 4, and the reflected light is guided to the reproduction detector 9. The light is photoelectric-converted by the reproduction detector 9, and a focusing error signal, a tracking error signal, an information reproduction signal, aberration, and the like are detected. The detection of the signals, aberration, and the like is performed by known methods. The controller 10 performs focusing operation, tracking operation, or the like on the basis of the signals detected by the reproduction detector 9. The controller 10 sets a drive signal for driving the liquid crystal device 6 in the driver 8 on the basis of the aberration detected by the reproduction detector 9, and the liquid crystal device 6 is driven by the driver 8 to correct the aberration.

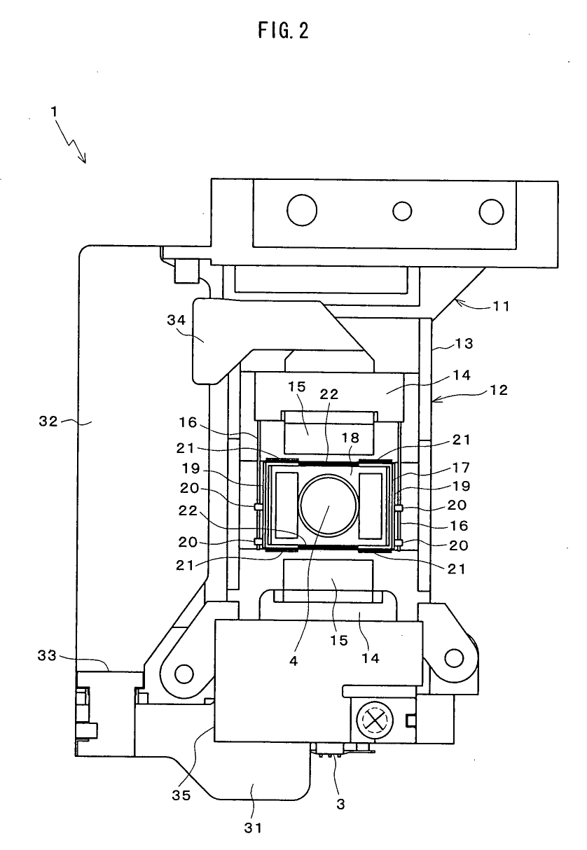

FIG. 2 is a schematic structure diagram of the optical pickup 1. A stationary frame 11 is fixed to a frame of a superordinate optical disk drive (not shown) or the like. To the stationary frame 11, a stationary frame 13 of an actuator 12, an intermediate board 32, a control board 31, and the like are fixed by screws and the like. The above-mentioned semiconductor laser device 3 is fixed to a side face of the stationary frame 11. On the intermediate plate 32, electronic parts such as a connector (not shown) and circuits are mounted. On the control board 31, the above-mentioned controller 10, a driver (not shown) for driving the semiconductor laser device 3, and electronic parts such as a power supply unit for supplying electric power to each part and circuits are mounted. On the control board 31, a heat sink 35 for dissipating heat generated by the electronic parts is attached. The boards 31 and 32 are electrically connected to each other via an FPC 33.

On the stationary frame 13 of the actuator 12, a pair of fixing parts 14 for fixing a pair of magnets 15 is provided. The pair of magnets 15 is an example of magnetic field generating means and is made of permanent magnets or the like. A plurality of suspension wires 16 having electric conductivity and elasticity are fixed to one of the fixing parts 14. Movable holders 17 and 18 are movably supported by the suspension wires 16 and disposed between the magnets 15. An FPC 19 is fixed to the side face facing the suspension wire 16 of the first movable holder 17 on the outside. The suspension wire 16 and the FPC 19 are electrically connected to each other via a terminal 20. The suspension wire 16 and the intermediate board 32 are electrically connected to each other via an FPC 34 and the like. A tracking coil 21 made of an electromagnetic coil is disposed on the side face facing the magnet 15 of the first movable holder 17. A focusing coil 22 made of an electromagnetic coil is disposed on the side face of the second movable holder 18 on the inner side. The terminals of the coils 21 and 22 and the suspension wire 16 are electrically connected to each other via the FPC 19.

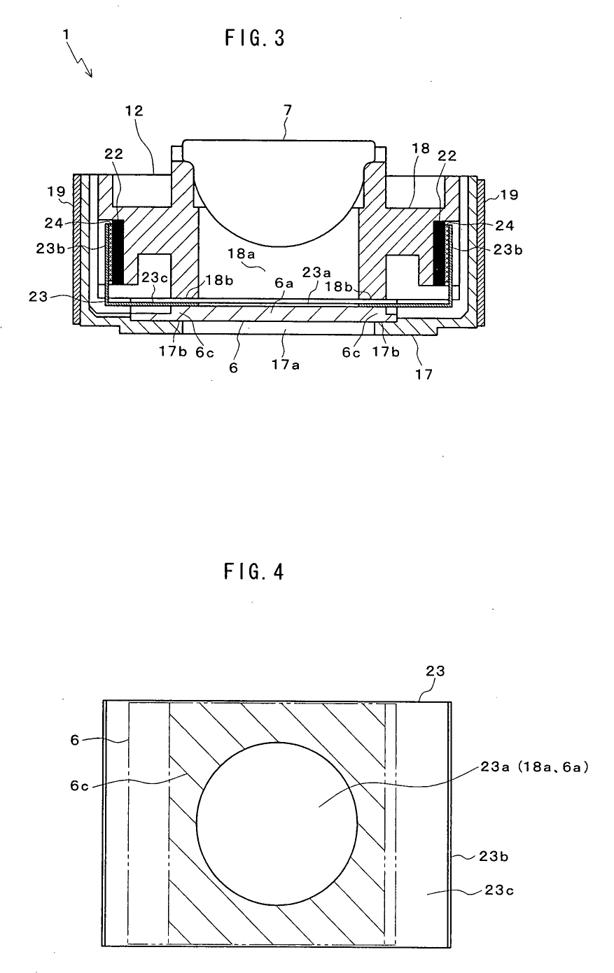

FIG. 3 is a cross section of the movable holders 17 and 18 of the actuator 12. Openings 17a and 18a are formed in the center portion of the movable holders 17 and 18, respectively. By fitting the second movable holder 18 to the inside of the first movable holder 17, the movable holders 17 and 18 are fixed, and the openings 17a and 18a are concentrically communicated with each other. The liquid crystal device 6 is fixed and held inside of the first movable holder 17 so as to cover the opening 17a. The objective lens 7 is fixed and held so as to cover the opening 18a on the side opposite to the liquid crystal device 6 of the second movable holder 18. On the side opposite to the liquid crystal device 6 of the second movable holder 18, the beam splitter 4, collimator lens 5, driver 8, and reproduction detector 9 are disposed with being fixed to the stationary frames 11 and 13. A laser beam from the semiconductor laser device 3 passes through the liquid crystal device 6 via the opening 17a of the first movable holder 17 from the lower side of FIG. 3 and is incident on the objective lens 7 via the opening 18a of the second movable holder 18. Then the laser beam goes out from the objective lens 7 to the upper side in FIG. 3, and is converged on the information recording face 2a of the optical disk 2. The driver 8 and the liquid crystal device 6 are electrically connected to each other via the suspension wire 16, the FPC 19, and the like. The driver 8 and the reproduction detector 9 are electrically connected to the controller 10 via the FPCs 33, 34 and the boards 31, 32, respectively.

Electric power is supplied from the control board 31 shown in FIG. 2 via the FPC 33, the intermediate board 32, the FPC 34, the suspension wires 16, the terminal 20, and the FPC 19 to the tracking coil 21, the focusing coil 22, or the liquid crystal device 6. When electric power is supplied to the coils 21 and 22 and current flows, magnetic fields and heat are generated from the coils 21 and 22. By the magnetic field of the tracking coil 21 and the magnetic field of the magnet 15, fine movement adjustment is performed in a plane parallel with the information recording face 2a of the optical disk 2 with respect to the stationary frames 11 and 13 of the movable holders 17 and 18, and the tracking operation for guiding a laser beam to one point on the information recording face 2a is performed by reciprocating movement of the objective lens 7 in parallel with the information recording face 2a. By the magnetic field of the focusing coil 22 and the magnetic field of the magnet 15, fine movement adjustment is performed in the direction perpendicular to the information recording face 2a of the optical disk 2 with respect to the stationary frames 11 and 13 of the movable holders 17 and 18, and the focusing operation for adjusting the focal point of the laser beam to one point on the information recording face 2a is performed by moving the objective lens 7 in the direction perpendicular to the information recording face 2a.

In a state where the movable holders 17 and 18 are fixed as shown in FIG. 3, a heat transfer plate 23 as an example of a heat transfer member is disposed in a space formed between the movable holders 17 and 18. The heat transfer plate 23 is formed in a recessed plate shape made of a metal or synthetic resin having high thermal conductivity. The heat transfer plate 23 is thin and thus flexible. Both ends 23b of the heat transfer plate 23 are bonded to the focusing coil 22 by an adhesive 24. The adhesive 24 is an example of a bonding member and has thermal conductivity and adhesiveness.

FIG. 4 is a plane view of the heat transfer plate 23. An opening 23a transmitting a laser beam without interruption is formed in a center portion 23c of the heat transfer plate 23. The diameter of the opening 23a is smaller than that of the opening 17a of the first movable holder 17, and is almost equal to that of the opening 18a of the second movable holder 18. Consequently, an effective area 6a of the liquid crystal device 6 capable of transmitting the laser beam coincides with the openings 23a and 18a. In a state where the first and second movable holders 17 and 18 are fixed as shown in FIG. 3, the center portion 23c of the heat transfer plate 23 is in contact with an outside portion 6c of the effective area 6a in the liquid crystal device 6. The outside portion 6c of the effective area 6a in the liquid crystal device 6 is a hatched part in FIG. 4. The center portion 23c of the heat transfer plate 23 is in contact with the whole outside portion 6c. Therefore, heat generated during driving of the focusing coil 22 is certainly transferred to the liquid crystal device 6 via the heat transfer plate 23, and the liquid crystal device 6 is heated.

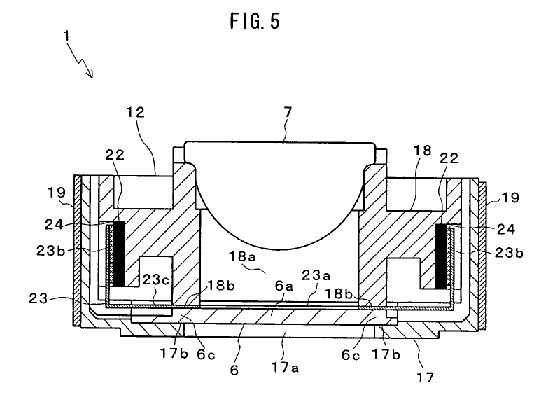

In FIG. 3, the center portion 23c of the heat transfer plate 23 is in contact with only the outside portion 6c of the effective area 6a in the liquid crystal device 6. As shown in FIG. 5, the center portion 23c of the heat transfer plate 23 may be in contact with not only the outside portion 6c of the liquid crystal device 6 but also an end face 18b of the second movable holder 18 facing the outside portion 6c. In FIG. 5, an end face 18b of the second movable holder 18 is projected to the side of the center portion 23c of the heat transfer plate 23 and is in contact with the center portion 23c with predetermined pressure. In addition, for example, the thickness of the heat transfer plate 23 may be increased, or the whole face on the side opposite to the objective lens 7 of the second movable holder 18 may be projected to the opposite side.

With the above configuration, heat generated by the focusing coil 22 for slightly moving the movable holders 17 and 18 is reliably transmitted to the liquid crystal device 6 via the heat transfer plate 23 disposed inside of the first movable holder 17 and dissipation of the heat into the air is suppressed. Therefore, the liquid crystal device 6 can be efficiently heated without uselessly consuming the electric power, and decrease in the response of the liquid crystal device 6 when temperature is low can be prevented. It is unnecessary to integrally provide a heat generator such as an ITO film for the liquid crystal device 6 at the stage of manufacturing the liquid crystal device 6, and the countermeasure can be taken by an optical pickup manufacturer himself, so that the cost of the liquid crystal device 6 and the optical pickup 1 can be suppressed. Further, since no heat generator is provided inside of the liquid crystal device 6, it can prevent the situation that the transmittance of the liquid crystal device 6 drops and it causes deterioration in aberration. Since the center portion 23c of the heat transfer plate 23 is in contact with the outside portion 6c of the effective area 6a in the liquid crystal device 6, the amount of light passing through the liquid crystal device 6 is not decreased, and the performance of the liquid crystal device 6 can be prevented from deteriorating.

By making the center portion 23a of the heat transfer plate 23 in contact with the outside portion 6c of the effective area 6a in the liquid crystal device 6 and the end face 18a of the second movable holder 18 facing the outside portion 6c in the state where the movable holders 17 and 18 are fixed to each other as shown in FIG. 5, the heat transfer plate 23 and the liquid crystal device 6 can be sandwiched by facing surfaces 17b and 18b of the movable holders 17 and 18 so as to be closely attached to each other by secure surface contact. Consequently, the heat generated by the focusing coil 22 is transferred to the liquid crystal device 6 via the heat transfer plate 23 more reliably. Thus, while further suppressing useless consumption of the electric power, the liquid crystal device 6 is efficiently heated, and decrease in the response of the liquid crystal device 6 at low temperature can be prevented.

Further, the semiconductor laser device 3 having high general versatility is used as a light source, the magnet 15 having high general versatility is used as magnetic field generating means, the adhesive 24 having thermal conductivity, adhesiveness, high versatility, and high usability is used as bonding means, the heat transfer plate 23 having heat conductivity, flexibility, and high mass productivity is used as a heat transfer member, the focusing coil 22 is also used as heat generating means of the liquid crystal device 6. Consequently, the number of parts is reduced, the cost of the parts is suppressed, further reduction in the cost and improvement in assembling performance of the optical pickup 1 can be realized. Since the heat transfer plate 23 has flexibility, both of the ends 23b of the heat transfer plate 23 can be bonded to the focusing coil 22 with the adhesive 24 while allowing the situation such that the transfer heat plate 23 is deflected in a state where the first and second movable holders 17 and 18 are fixed and comes into contact with the outer part 6c of the effective area 6a in the liquid crystal device 6. Thus the positioning of the heat transfer plate 23 at the time of bonding can be simplified, and the assembling performance of the optical pickup 1 can be improved.

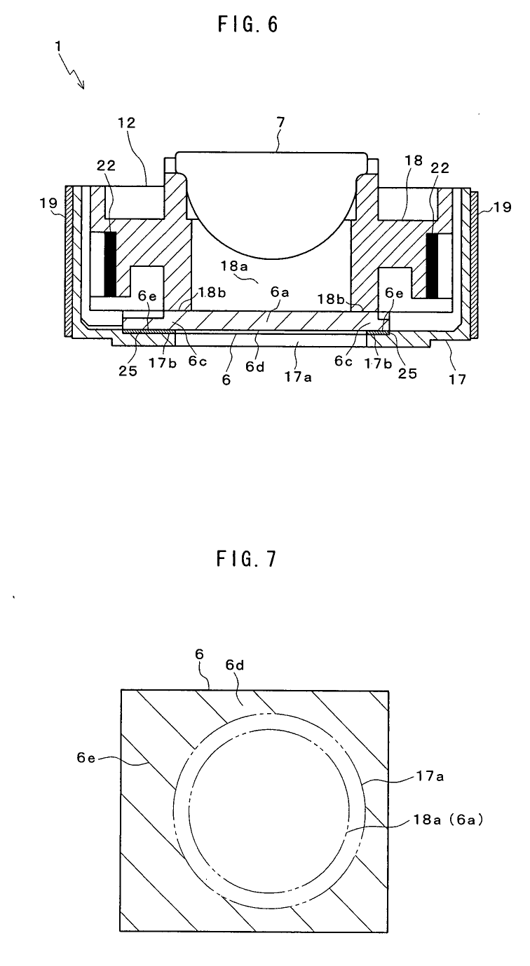

FIGS. 6 to 14 show other embodiments of the present invention. In FIGS. 6 to 14, the same reference numerals are designated to parts which are the same as or corresponding to those in FIGS. 1 to 5. FIG. 6 is a cross section of the movable holders 17 and 18 of the actuator 12 according to another embodiment. In this embodiment, in place of the heat transfer plate 23 shown in FIG. 3 and the like, a heat generating member 25 separate from the liquid crystal device 6 is provided. The heat generating member 25 consists of a coil to which power is supplied and which generates heat, a thermister, and a resistor or a resistive element such as special paint or the like. The heat generating member 25 is fixed to a step face 17b of the first movable holder 17 so as not to extend to the opening 17a. In a state where the movable holders 17 and 18 are fixed, a part of the outside portion 6c of the effective area 6a in the liquid crystal device 6 and a part of the heat generating member 25 are sandwiched between the facing faces 17b and 18b of the movable holders 17 and 18, and the heat generating member 25 is closely attached to an outside portion 6e of the opening 17a in a surface 6d facing the step face 17b of the liquid crystal device 6. The outside portion 6e of the surface 6d of the liquid crystal device 6 is a hatched part in FIG. 7. The heat generating member 25 is closely adhered to the whole or part of the outside portion 6e. Consequently, when electric power is supplied to make the heat generating member 25 generate heat, the heat is transferred from the heat generating member 25 directly to the liquid crystal device 6, and the liquid crystal device 6 is heated.

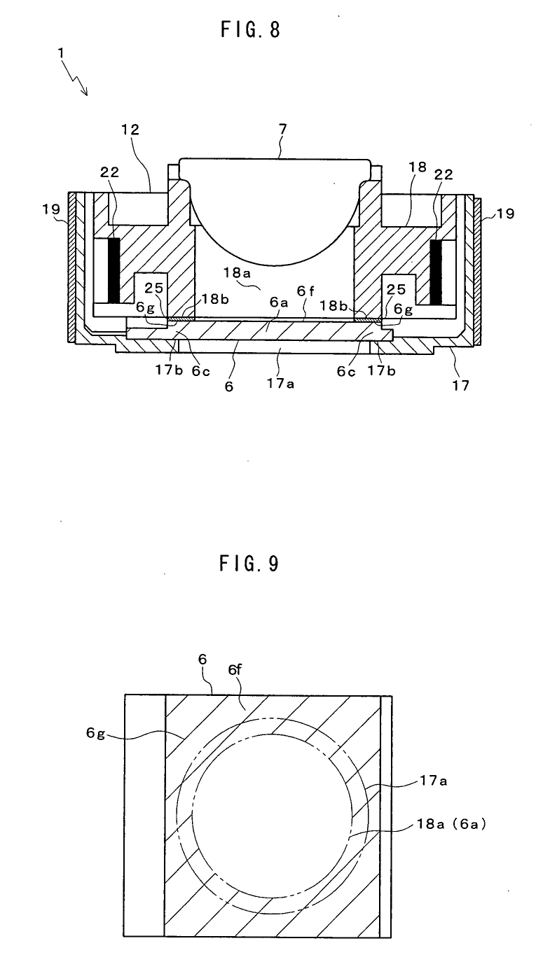

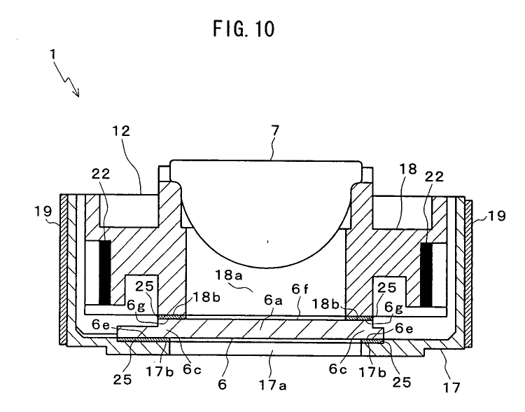

In FIG. 6, the heat generating member 25 is fixed to the step face 17b facing the liquid crystal device 6 of the first movable holder 17. The heat generating member 25 may be fixed to the end face 18b facing the liquid crystal display 6 of the second movable holder 18 as shown in FIG. 8. In FIG. 8, the heat generating member 25 is fixed to the end face 18b of the second movable holder 18 so as not to extend to the opening 18a. In a state where the movable holders 17 and 18 are fixed, a part of the outside portion 6c of the effective area 6a in the liquid crystal device 6 and a part of the heat generating member 25 are sandwiched between the facing faces 17b and 18b of the movable holders 17 and 18, and the heat generating member 25 is closely attached to an outside portion 6g of the opening 18a in a surface 6f facing the end face 18b of the liquid crystal device 6. The outside portion 6g of the surface 6f of the liquid crystal device 6 is a hatched part in FIG. 9. The heat generating member 25 is closely attached to the whole or part of the outside portion 6g. Consequently, when electric power is supplied to make the heat generating member 25 generate heat, the heat is transferred from the heat generating member 25 directly to the liquid crystal device 6, and the liquid crystal device 6 is heated. Further, as shown in FIG. 10, the heat generating member 25 may be fixed to both of the step face 17b of the first movable holder 17 and the end face 18b of the second movable holder 18. The fixing position of the heat generating member 25, the position of adhesion to the liquid crystal device 6, and the like in FIG. 10 are similar to those described with reference to FIGS. 6 and 8. In such a manner, the heat generated by the heat generating members 25 is directly transmitted to the surfaces 6d and 6f of the liquid crystal device 6, thereby the liquid crystal device 6 is heated more efficiently.

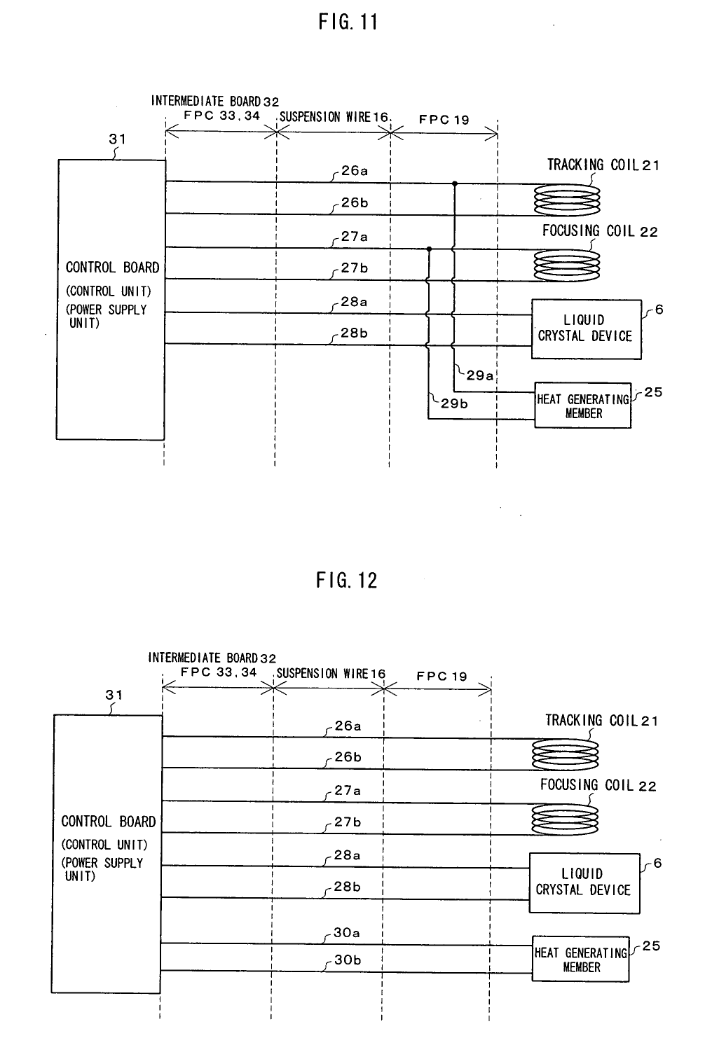

FIGS. 11 and 12 are diagrams showing power supply lines for supplying electric power from the control board 31 to each component provided on the movable holders 17 and 18. Power supply lines 26a, 26b, 27a, 27b, 28a, and 28b for supplying electric power from the control board 31 to the tracking coil 21, the focusing coil 22, or the liquid crystal device 6 are formed separately from each other on the FPCs 33 and 34, the intermediate board 32, the suspension wire 16, the FPC 19, and the like.

In the case of using, as the heat generating member 25, a resistor whose temperature at heat generation does not depend on the supplied electric power but is almost constant, it is unnecessary to perform the control of supplying (and interrupting) power to the heat generating member 25. Consequently, for example, as shown in FIG. 11, power supply lines 29a and 29b are formed so as to be branched from the power supply lines 26a and 27a of the coils 21 and 22 on the FPC 19 and connected to the heat generating member 25, and electric power is supplied from the control board 31 to the heat generating member 25 via the power supply lines 26a, 27a, 29a, and 29b. With this arrangement, the number of lines on the FPCs 33 and 34 and the intermediate board 32 and the number of the suspension wires 16 become smaller, and the cost can be suppressed. The electric power is supplied to the heat generating member 25 during the driving of the coils 21 and 22, and the heat generating member 25 generates heat. The heat is transferred directly from the heat generating member 25 to the liquid crystal device 6, and the liquid crystal device 6 is heated. Further, even when the electric power is supplied for long time and the heat generating member 25 continues to generate heat, the temperature at heat generation of the heat generating member 25 rises to a certain extent and, after that, is saturated, so that the liquid crystal device 6 is not heated excessively. Alternatively, the power supply lines connected to the heat generating member 25 may be formed by branching the power supply lines 26b, 27b, 28a, and 28b other than the power supply lines 26a and 27a.

In the case of using, as the heat generating member 25, a resistor whose temperature at heat generation depends on the magnitude of supplied electric power, the supply of electric power to the heat generating member 25 is controlled in accordance with the ambient temperature of the liquid crystal device 6. Consequently, for example, as shown in FIG. 12, power supply lines 30a and 30b for supplying electric power from the control board 31 to the heat generating member 25 are formed, separately from the power supply lines 26a, 26b, 27a, 27b, 28a, and 28b of the coils 21 and 22 and the liquid crystal device 6, on the FPCs 33 and 34, the intermediate board 32, the suspension wire 16, the FPC 19, and the like. With this arrangement, the electric power to the coils 21 and 22 and the liquid crystal device 6 is not consumed by the heat generating member 25, and the performance of the coils 21 and 22 and the liquid crystal device 6 can be prevented from deteriorating.

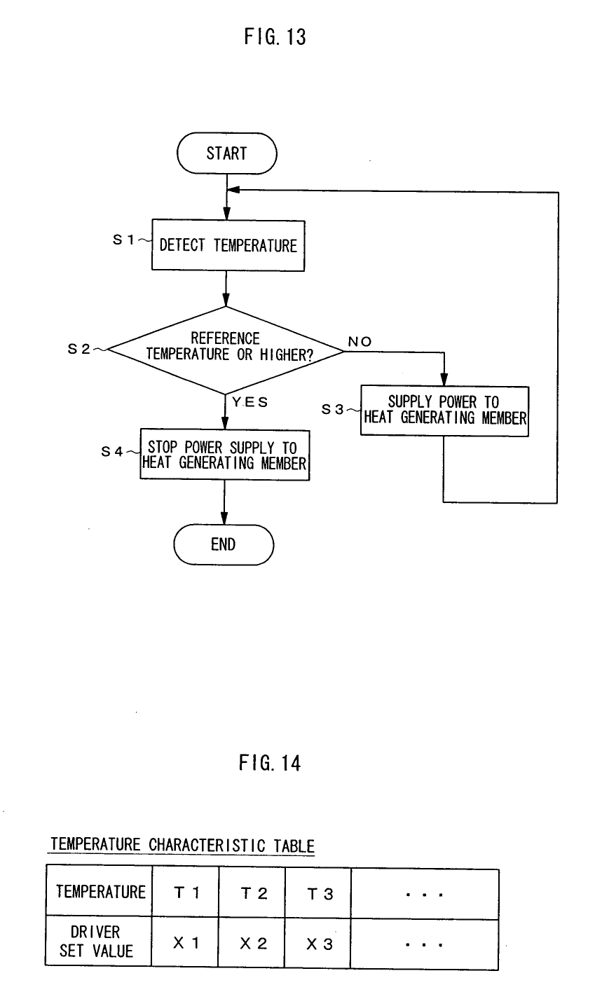

FIG. 13 is a flowchart showing the procedure of controlling the heat generating member 25. The procedure relates to detailed processes as a part of the main process executed by the controller 10 after start of the optical pickup 1. The controller 10 periodically executes the control on the heat generating member 25 in accordance with the procedure at the start and the normal operation of the optical pickup 1. For example, when the optical pickup 1 starts, on the basis of preset initial set values (a current value and a voltage value), the electric power is supplied to the tracking coil 21, the focusing coil 22, the liquid crystal device 6, and the like to execute the tracking operation, the focusing operation, and the initial operation of aberration correction or the like. Then the controller 10 detects the ambient temperature on the basis of the aberration detected by the reproduction detector 9 and the set values which are set in the driver 8 in order to drive the liquid crystal device 6 (step S1).

In a memory of the controller 10, information of a temperature characteristic table shown in FIG. 14 is recorded. The temperature characteristic table shows set values X1, X2, X3, . . . set in the driver 8 when the liquid crystal device 6 is driven by the driver 8 to correct aberration and the aberration can be corrected to a predetermined optimum value under the environment of temperatures T1, T2, T3, . . . (for example, temperatures of every +5° C.) within a predetermined temperature range (for example, the operation assurance temperature range of the optical pickup 1) at a development stage of the optical pickup 1. When aberration cannot be detected by the reproduction detector 9 due to the situation such that the optical disk 2 is not set, the controller 10 reads temperature corresponding to the initial set value set in the driver 8 from the temperature characteristic table and sets the read temperature as the ambient temperature of the liquid crystal device 6. When the reproduction detector 9 detects that aberration could have been corrected to a predetermined optimum value by the liquid crystal device 6 or the like, the controller 10 reads temperature corresponding to the set value on completion of aberration correction set in the driver 8 from the temperature characteristic table and sets the read temperature as the ambient temperature of the liquid crystal device 6.

After the ambient temperature is detected as described above, the controller 10 compares the detected temperature with a predetermined reference temperature (the lower limit value of the response speed of the liquid crystal device 6, for example, 1° C.). When the detected temperature is equal to or higher than the reference temperature (YES in step S2), without supplying electric power to the heat generating member 25 (step S4), the controller 10 finishes the routine. On the other hand, when the detected temperature is lower than the reference voltage (NO in step S2), the controller 10 supplies electric power to the heat generating member 25 via the power supply lines 30a and 30b (step S3) to make the heat generating member 25 generate heat, thereby heating the liquid crystal device 6. After that, the ambient temperature is detected again (step S1).

When the optical pickup 1 becomes in the state of normal operation and repeatedly executes the steps S1 to S3 and, after that, the detected temperature is equal to or higher than the reference temperature in step S2 (YES in step S2), the electric power supply to the heat generating member 25 is stopped (step S4) and the routine is finished. After that, as long as the optical pickup 1 operates, the controller 10 cyclically starts the operation from the step S1.

According to the above-described manner, the heat generating member 25 and the liquid crystal device 6 are sandwiched between the facing faces 17b and 18b of the movable holders 17 and 18 and closely attached to each other by secure surface contact. Consequently, by supplying electric power to the heat generating member 25 via the power supply lines 26a, 27a, 29a, 29b or the power supply lines 30a and 30b to make the heat generating member 25 generate heat, the heat is directly transferred to the liquid crystal device 6 and dissipation of the heat into the air is suppressed. Thus without uselessly consuming electric power, the liquid crystal device 6 can be efficiently heated and the response speed of the liquid crystal device 6 can be prevented from being dropped at low temperature. Since the heat generating member 25 is provided separately from the liquid crystal device 6 and it is unnecessary to provide a heat generator such as an ITO film integrally with the liquid crystal device 6 at the stage of manufacturing the liquid crystal device 6, the cost of the liquid crystal device 6 and the optical pickup 1 can be suppressed to be low. Further, since no heat generator is provided inside of the liquid crystal device 6, the transmittance of the liquid crystal device 6 does not decrease and it does not cause deterioration in aberration. Since the heat generating member 25 is in contact with the outside portions 6e and 6g of the effective area 6a in the liquid crystal device 6, the amount of light passing through the liquid crystal device 6 does not decrease, and the performance of the liquid crystal device 6 can be prevented from deteriorating.

On the basis of the aberration detected by the reproduction detector 9 and the set value set in the driver 8 to drive the liquid crystal device 6, the ambient temperature is detected, and only at low temperature when the detected temperature is lower than the predetermined reference temperature, the heat generating member 25 is allowed to generate heat by supplying electric power to the heat generating member 25 via the power supply lines 30a and 30b. When the detected temperature becomes equal to or higher than the predetermined reference temperature, the electric power supply to the heat generating member 25 is stopped and the heat generation by the heat generating member 25 can be stopped. Consequently, while further suppressing useless consumption of electric power, the liquid crystal device 6 can be efficiently heated, and decrease in the response speed of the liquid crystal device 6 at low temperature can be prevented. In addition, it is unnecessary to separately provide temperature detecting means, so that the cost of the optical pickup 1 can be suppressed to be low.

The present invention can employ various modes other than the foregoing embodiments. In the embodiment shown in FIGS. 1 to 5, the example of transferring heat generated by the focusing coil 22 to the liquid crystal device 6 via the heat transfer plate 23 has been described. However, the invention is not limited to the embodiment. The heat generated by the tracking coil or the heat generated by both of the tracking coil and the focusing coil may be transferred to the liquid crystal device by a heat transfer member.

Although the case of applying the present invention to prevention of decrease in the response speed of the liquid crystal device 6 for correcting wave front aberration has been described in the foregoing embodiments, the present invention can be also applied to prevention of decrease in the response speed of a liquid crystal device for correcting other aberration such as wave front aberration occurring due to thickness error of a light transmission film of an optical disk, according to the shape of an objective lens, or the like, and coma aberration which occurs after correction of the wave front aberration or the like.

What is claimed is:

1. An optical pickup comprising:
a semiconductor laser device for emitting a laser beam;
an objective lens for adjusting focal point of a laser beam onto an optical disk;
a liquid crystal device for correcting aberration by changing phase of a transmitting laser beam on an optical path of the laser beam;
a movable holder for holding the objective lens and the liquid crystal device;
a stationary frame for movably supporting the movable holder; and
an electromagnetic coil and a magnet for slightly moving the movable holder relative to the stationary frame,
wherein the movable holder is constructed by a first movable holder in which an opening is formed and a second movable holder which is fit and fixed to the inside of the first movable holder and in which an opening is formed so as to communicate with the opening in the first movable holder,
the liquid crystal device is fixed inside of the first movable holder so as to cover the opening,
the objective lens is fixed to the second movable holder so as to cover the opening,
the electromagnetic coil is disposed on a side face of the second movable holder, and
a heat transfer plate having heat conductivity and flexibility for transferring heat generated by the electromagnetic coil to the liquid crystal device, whose end is bonded to the electromagnetic coil by an adhesive having heat conductivity and adhesiveness, which is disposed inside of the first movable holder in a state where the first and second movable holders are fixed, and whose center portion is in contact with an outside portion of an effective area capable of transmitting a laser beam in the liquid crystal device and a face of the second movable holder facing said outside portion.

2. An optical pickup comprising:
a semiconductor laser device for emitting a laser beam;
an objective lens for adjusting focal point of a laser beam onto an optical disk;
a liquid crystal device for correcting aberration by changing phase of a transmitting laser beam on an optical path of the laser beam;
a movable holder for holding the objective lens and the liquid crystal device;
a stationary frame for movably supporting the movable holder; and
an electromagnetic coil and a magnet for slightly moving the movable holder relative to the stationary frame,
wherein the movable holder is constructed by a first movable holder in which an opening is formed and a second movable holder which is fit and fixed to the inside of the first movable holder and in which an opening is formed so as to communicate with the opening in the first movable holder,
the liquid crystal device is fixed inside of the first movable holder so as to cover the opening,
the objective lens is fixed to the second movable holder so as to cover the opening,
the electromagnetic coil is disposed on a side face of the second movable holder, and
the optical pickup further comprises:
a heat generating member for generating heat when electric power is supplied, the heat generating member being sandwiched together with an outside portion of an effective area capable of transmitting a laser beam in the liquid crystal device between facing surfaces of the first and second movable holders and closely attached to the outside portion in a state where the first and second movable holders are fixed;
a power supply line for supplying electric power to the heat generating member;
detecting means for receiving light reflected from an optical disk and detecting an electric signal;
driving means for driving the liquid crystal device; and
control means for detecting temperature on the basis of the electric signal detected by the detecting means and a set value set in the driving means in order to drive the liquid crystal device and, only in the case where the detected temperature is lower than a predetermined reference temperature, supplying electric power to the heat generating member to make the heat generating member generate heat.

3. An optical pickup comprising:
a light source for emitting light;
an objective lens for adjusting focal point of light from the light source onto an optical disk;
a liquid crystal device for correcting aberration by changing phase of transmitting light on an optical path of the light from the light source;
a movable holder for holding the objective lens and the liquid crystal device;
a stationary frame for movably supporting the movable holder; and
an electromagnetic coil and magnetic field generating means for slightly moving the movable holder relative to the stationary frame,
wherein the movable holder is constructed by a first movable holder in which an opening is formed and a second movable holder which is fit and fixed to the inside of the first movable holder and in which an opening is formed so as to communicate with the opening in the first movable holder,
the liquid crystal device is fixed inside of the first movable holder so as to cover the opening,
the objective lens is fixed to the second movable holder so as to cover the opening,
the electromagnetic coil is disposed on a side face of the second movable holder, and
the optical pickup further comprises a heat transfer member having heat conductivity for transferring heat generated by the electromagnetic coil to the liquid crystal device, whose end is bonded to the electromagnetic coil by bonding means having heat conductivity and adhesiveness, which is disposed inside of the first movable holder in a state where the first and second movable holders are fixed, and whose center portion is in contact with an outside portion of an effective area capable of transmitting light from the light source in the liquid crystal device.

4. The optical pickup according to claim 3, wherein the heat transfer member is also in contact with a face of the second movable holder facing the outside portion of the effective area in the liquid crystal device in a state where the first and second movable holders are fixed.

5. An optical pickup comprising:
a light source for emitting light;
an objective lens for adjusting focal point of the light from the light source onto an optical disk;
a liquid crystal device for correcting aberration by changing phase of transmitting light on an optical path of the light from the light source;
a movable holder for holding the objective lens and the liquid crystal device;
a stationary frame for movably supporting the movable holder; and
an electromagnetic coil and magnetic field generating means for slightly moving the movable holder relative to the stationary frame,
wherein the movable holder is constructed by a first movable holder in which an opening is formed and a second movable holder which is fit and fixed to the inside of the first movable holder and in which an opening is formed so as to communicate with the opening in the first movable holder,
the liquid crystal device is fixed inside of the first movable holder so as to cover the opening,
the objective lens is fixed to the second movable holder so as to cover the opening,
the electromagnetic coil is disposed on a side face of the second movable holder, and
the optical pickup further comprises:
a heat generating member for generating heat when electric power is supplied, the heat generating member being sandwiched together with an outside portion of an effective area capable of transmitting light from the light source in the liquid crystal device between facing surfaces of the first and second movable holders and closely attached to the outside portion in a state where the first and second movable holders are fixed; and
a power supply line for supplying electric power to the heat generating member.

6. The optical pickup according to claim 5, further comprising:
detecting means for receiving light reflected from an optical disk and detecting an electric signal;
driving means for driving the liquid crystal device; and
control means for detecting temperature on the basis of the electric signal detected by the detecting means and a set value set in the driving means in order to drive the liquid crystal device and, on the basis of a result of comparison between the detected temperature and predetermined reference temperature, controlling supply of electric power to the heat generating member.
